(19) United States
(12) Patent Application Publication
(10) Pub. No.: US 2011/0256978 A1
(43) Pub. Date: Oct. 20, 2011

(54) Method and Device for Starting a Hybrid Vehicle

(76) Inventor: Jens-Werner Falkenstein, Aalen (DE)

(21) Appl. No.: 12/998,402

(22) PCT Filed: Sep. 25, 2009
(86) PCT No.: PCT/EP2009/062459

§ 371 Date: Jun. 22, 2011

(30) Foreign Application Priority Data
Oct. 24, 2008 (DE) 10 2008 043 159.1

(51) Int. Cl. B60W 20/00; B60W 10/02

(52) U.S. Cl. 477/5; 477/6; 180/65.21; 903/902

(57) ABSTRACT

In a method for starting a hybrid vehicle having a first drive unit and a second drive unit, the setpoint starting torque is generated by the second drive unit. In this method, a starting clutch for connecting the first drive unit is brought into the slipping state when a predefined setpoint torque of the second drive unit is exceeded.

### BACKGROUND OF THE INVENTION

1. Field of the Invention

The present invention relates to a method for starting a hybrid vehicle, having a first drive unit and a second drive unit, the setpoint starting torque being generated by the second drive unit, and a device for carrying out the method.

2. Description of Related Art

For conventional motor vehicle drives, a starting operation is usually carried out using a sliding starting clutch which is activated by the driver via the clutch pedal. For automatic transmissions, an actuator which is activated by the control system is used.

Vehicles having a hybrid drive structure usually have an internal combustion engine as a first drive unit and an electric motor or a hydraulic motor as a second drive unit. Additional drive units are also possible. Thus, the torque may be applied by the drive units during the starting operation of the hybrid vehicle.

A parallel hybrid drive for a motor vehicle which has an internal combustion engine as well as an electric machine as a drive is known from published German patent application document DE 195 03 500 A1 related to the same species. The drive torque is generated solely by the electric machine when the vehicle is driven in the forward direction and/or in the reverse direction.

### BRIEF SUMMARY OF THE INVENTION

The method according to the present invention for starting a hybrid vehicle has the advantage that the second drive unit drives the hybrid vehicle in a wear-free manner. As the result of a starting clutch for coupling the first drive unit to the drive train being brought into the slipping state only when a predefined setpoint torque of the second drive unit is exceeded, the slipping state of the starting clutch is used only temporarily to avoid the temperature increases which then occur. The activations of the starting clutch and that of the second drive unit are thus coordinated with one another.

The wear on the starting clutch which is caused by the slipping state of the clutch is reduced. In addition, impairment of the oil from clutches operating in the oil bath as the result of shear forces and temperature peaks is prevented.

In one embodiment of the present invention, a setpoint starting torque of the hybrid vehicle which is limited to a maximum torque is transmitted to the second drive unit. Since the setpoint starting torque of the hybrid vehicle is basically intended to be generated jointly by the first and second drive units, when the maximum torque of the second drive unit is exceeded, the first drive unit for the starting operation for the hybrid vehicle is switched on, and is coupled to the drive train, in particular with the aid of the starting clutch.

The maximum torque of the second drive unit is a function of the instantaneous operating state of the units of the drive train of the hybrid vehicle. The instantaneous operating state is influenced by the limits of the second drive unit, by the state of an energy storage, by the instantaneous state of the first drive unit and/or additional drive units, and/or by the conditions of the roadway on which the hybrid vehicle is traveling, which have an effect of the entire drive via the traction control system, for example.

In one refinement, a clutch torque to be transmitted by the slipping starting clutch is formed from the difference between the setpoint starting torque of the hybrid vehicle and the maximum torque of the second drive unit when the setpoint starting torque exceeds the maximum torque of the second drive unit. Only in this case is the starting clutch brought into the slipping state. At this moment the first and second drive units jointly participate in starting the hybrid vehicle.

The clutch torque is limited to a maximum clutch torque as a function of the instantaneous operating state of the starting clutch and/or the drive units, and/or of the roadway conditions. This limitation is used to protect the clutch, for example to prevent the clutch from being overstressed by excessive temperature. The maximum clutch torque is also a function of an internal combustion engine maximum torque when, for example, the first drive unit is designed as an internal combustion engine. This internal combustion engine maximum torque is reduced in particular subsequent to the first ignitions after starting.

In addition, the maximum clutch torque is a function of the instantaneous state of the entire drive.

For setting an increase in torque, the setpoint starting torque is advantageously greater than the maximum clutch torque. For such an increase in torque, a greater torque is delivered to the wheels than is generated by the first drive unit.

In particular when the vehicle is started on an uphill roadway or is driven with a trailer, such an increase in torque, which simulates the increase from a torque converter of an automatic transmission and results in an increased transmission input torque, has a significant advantage over a slipping starting clutch, since mechanical stress on the starting clutch may be reduced. This allows comfortable crawling and starting operations of the hybrid vehicle to be easily carried out. The dimensions of the clutch may be smaller, resulting in cost advantages.

In another embodiment, a third drive unit is coupled to the first drive unit, and is driven by same in order to generate power which is used by the second drive unit. When a third drive unit is used, the maximum torque of the second drive unit and the maximum clutch torque which may be received by the clutch are likewise influenced by the operating state of this third drive unit, for example in the form of the generator power which it supplies.

The clutch torque to be transmitted by the slipping clutch influences the first drive unit. To minimize this influence, the clutch torque to be transmitted by the slipping clutch to the first drive unit is pilot-controlled. This has the advantage that an idle speed controller or a starting controller is spared, and drops in rotational speed during transitions between a disengaged and a slipping clutch are avoided. If a third drive unit is coupled to the first drive unit, the third drive unit is also influenced by the clutch torque. The clutch torque may also be completely pilot-controlled at the third drive, or may be distributed between the first and third drive units. Mechanical gear ratios between the first and the third drive unit must be taken into account. An idle speed controller or a starting controller may act on the first and/or the third drive unit.

The torques of the first and second and/or third drive unit are advantageously smoothly adapted to the driving operation of the hybrid vehicle when rotational speed equality of the input rotational speed and the output rotational speed of the starting clutch is reached, when the starting clutch goes from the slipping state to the engaged state. In the driving operation, primarily the drive torque from the first drive unit is perceived. The torque of the second drive unit is decreased in a ramped manner, for example, while the torque of the first drive unit is increased in a ramped manner in order to avoid mechanical effects on the hybrid vehicle during the adaptation.

A particularly efficient variant of the method according to the present invention is achieved when the first drive unit is designed as an internal combustion engine, and the second and third drive units are each designed as an electric motor.

Starting is advantageously carried out by the second drive unit with the starting clutch disengaged, while the first drive unit is shut off. The first drive unit is started when the setpoint starting torque increases, but before the setpoint starting torque exceeds the maximum torque of the second drive unit. The time until an actual torque of the first drive unit is available is thus bridged.

In one embodiment, a torque reserve at the first drive unit is requested when the setpoint starting torque increases, but before the setpoint starting torque exceeds the maximum torque of the second drive unit. The torque reserve is thus requested before the starting clutch goes into the slipping state and the torque decreases at the first drive unit. At a later point in time at which the starting clutch has reached the slipping state, the torque reserve has already been built up.

In order to request the torque reserve in a timely manner, an interval of the setpoint starting torque from the maximum torque of the second drive unit is determined as a function of an operation speed of an accelerator pedal.

Another refinement of the present invention concerns a device for starting a hybrid vehicle which has a first drive unit and a second drive unit, the starting torque being generated by the second drive unit. In order to spare the starting clutch to the greatest extent possible during the starting operation, means are present which bring a starting clutch for coupling the first drive unit into the slipping state when a predefined setpoint torque of the second drive unit is exceeded. Such a design has the advantage that the contribution of the first and second drive units to starting the hybrid vehicle may be precisely coordinated by controlling the starting clutch as a function of the power of the second drive unit. Wear on the starting clutch due to mechanical abrasion and temperature influences is largely prevented, thus prolonging the service life of the clutch.

In one embodiment, the second drive unit in the drive train is connected downstream from the starting clutch, and acts directly or via a transmission on at least one drive wheel of the hybrid vehicle. This ensures that the second drive unit alone is also able to start the vehicle. Another advantage is that a torque converter, which is known from vehicles having an automatic transmission, may be simulated, thus allowing comfortable crawling and starting operations, for example starting on an uphill roadway even without the first drive unit. The physical use of such a torque converter may thus be dispensed with.

### BRIEF DESCRIPTION OF THE DRAWINGS

FIG. 1 shows a schematic illustration of control of a starting operation for a conventional drive train according to the related art.

FIG. 2 shows a schematic illustration of control of a starting operation for a hybrid drive train according to the present invention.

FIG. 3 shows a schematic flow chart of one exemplary embodiment of the method according to the present invention.

### DETAILED DESCRIPTION OF THE INVENTION

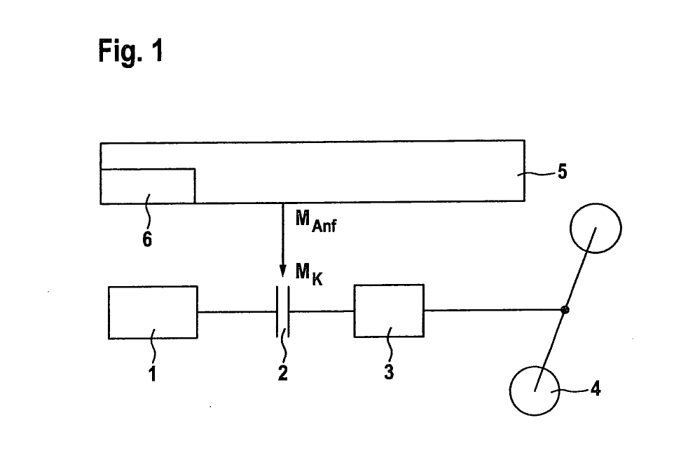

FIG. 1 shows a system for starting in a conventional drive train according to the related art. An internal combustion engine 1 is connected to an automated starting clutch 2, which in turn leads to a transmission 3 which transmits the torque applied by internal combustion engine 1 to wheels 4. The starting operation is controlled via a control unit 5 which has an idle speed controller 6 for internal combustion engine 1.

A setpoint starting torque M_{Anf} is ascertained by control unit 5 based on an accelerator and/or brake pedal position (not illustrated in greater detail) which is specified by the driver of the hybrid vehicle, or based on a driver assistance system, and is specified as setpoint torque M_{K} for the torque to be transmitted by slipping starting clutch 2. This setpoint torque M_{K} is adjusted to the slipping clutch linings by an appropriate contact force. Idle speed controller 6 prevents internal combustion engine 1 from shutting down due to the torque received from slipping starting clutch 2. Setpoint torque M_{K} of starting clutch 2 is transmitted to wheels 4 via transmission 3.

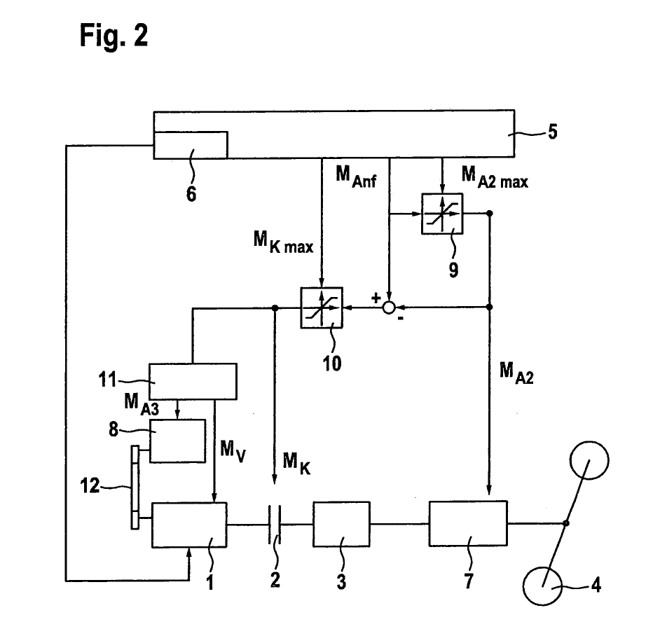

For a hybrid vehicle, the drive train as illustrated in FIG. 2 is composed of an internal combustion engine 1 which is connected to starting clutch 2. Starting clutch 2 leads to a transmission 3 which is connected to a further drive unit in the form of a first electric motor 7 which acts on the transmission output shaft. The further drive unit in the form of first electric motor 7 may also be situated between transmission 3 and starting clutch 2. Wheels 4 form the end of the drive train. When first electric motor 7 is situated downstream from starting clutch 2, it is advantageously able to act directly on wheels 4 without slip.

A second electric motor or a belt starter generator 8 is mounted at belt drive 12 of internal combustion engine 1. Control unit 5 acts on a first limiter 9 which is connected to first electric motor 7. Control unit 5 is also connected to a clutch limiter 10 which acts directly on clutch 2 and a torque distributor 11. Torque distributor 11 is connected to internal combustion engine 1 and second electric motor 8.

An idle speed controller 6 for internal combustion engine 1 is contained within control unit 5.

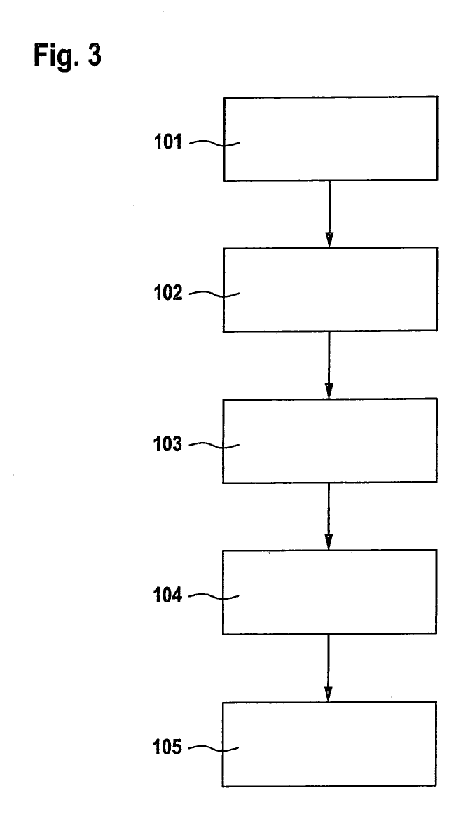

The method according to the present invention is explained with reference to FIG. 3. Internal combustion engine 1 is in idle mode and starting clutch 2 is disengaged in block 101. First electric motor 7 and wheels 4 are at rest. The transmission ratio of transmission 3 is assumed to be i=1.

In block 102, based on the position of the accelerator and/or brake pedal specified by the driver of the hybrid vehicle or by the specification of a driver assistance system, control unit 5 determines a setpoint starting torque M_{Anf} which is to be generated jointly by internal combustion engine 1 and first electric motor 7 and second electric motor 8.

In block 103, setpoint starting torque M_{Anf} to be jointly generated is initially delivered to limiter 9, for which a maximum torque M_{A2max} is specified by control unit 5. Maximum torque M_{A2max} is ascertained by control unit 5 as a function of the instantaneous state of first electric motor 7, second electric motor 8, and internal combustion engine 1, as well as an energy storage (not illustrated in greater detail).

Limiter 9 limits setpoint starting torque M_{Anf}, resulting in a setpoint torque M_{A2} for first electric motor 7. If setpoint starting torque M_{Anf} is less than maximum torque M_{A2max} for first electric motor 7, setpoint torque M_{A2} corresponds to setpoint starting torque M_{Anf}, and the starting torque of the hybrid vehicle is applied solely by first electric motor 7.

If setpoint starting torque M_{Anf} is greater than maximum torque M_{A2max} of first electric motor 7, the limiter engages and electric motor 7 is able to apply only maximum torque M_{A2max} as setpoint torque M_{A2}.

In block 104 a difference between setpoint starting torque M_{Anf} and setpoint torque M_{A2} of first electric motor 7 which is limited to maximum torque M_{A2max} is computed. This difference is zero as long as setpoint starting torque M_{Anf} is less than maximum torque M_{A2max} and therefore corresponds to limited setpoint torque M_{A2}. The difference is greater than zero when setpoint starting torque M_{Anf} exceeds maximum torque M_{A2max}.

This difference is delivered to clutch limiter 10, which receives a maximum clutch torque M_{Kmax} which is specified by control unit 5. Maximum clutch torque M_{Kmax} is also determined by control unit 5 in that the instantaneous operating state of starting clutch 2 and of internal combustion engine 1 as well as of first and second electric motors 7 and 8, respectively, and of energy storage 12 are taken into account. If the torque remains below maximum clutch torque M_{Kmax}, the difference, as clutch torque M_{K} which is jointly supplied by internal combustion engine 1 and second electric motor 8 and to be transmitted in a slipping manner to starting clutch 2, is transmitted to the drive train and to transmission 3. Otherwise, clutch torque M_{K} corresponds to maximum clutch torque M_{Kmax}.

In general, for a transmission ratio of transmission 3 of i≠1, the difference corresponding to transmission ratio i must be recomputed. The recomputed difference is supplied to clutch limiter 10.

Starting clutch 2 remains completely disengaged as long as the difference is zero. If setpoint starting torque M_{Anf} exceeds maximum torque M_{A2max}, which results in a positive difference, starting clutch 2 goes into the slipping state. Setpoint starting torque M_{Anf} is then applied jointly by first electric motor 7 and internal combustion engine 1 together with second electric motor 8.

In torque distributor 11, clutch torque M_{K} is distributed to setpoint torque Mᵥ for internal combustion engine 1 and setpoint torque M_{A3} for second electric motor 8 (block 105).

The mechanical transmission ratio between internal combustion engine 1 and second electric motor 8 is taken into account. This pilot control is carried out to spare idle speed controller 6. Starting by using a starting clutch 2 which is preferably disengaged and which is in the slipping state only when necessary, reduces the wear on the starting clutch and allows a crawling operation to be prolonged. In addition, a setpoint starting torque M_{Anf} is illustrated which is greater than maximum clutch torque M_{Kmax}, which is equivalent to a converter overshoot.

First electric motor 7 and second electric motor 8 are connected to a common energy storage, which is not illustrated in greater detail in FIG. 2. In order to meet the power requirements of first electric motor 7, second electric motor 8 provides electric power which is withdrawn from internal combustion engine 1. In this case, first and second electric motors 7 and 8, respectively, operate in series. First electric motor 7 operates as a motor and drives the hybrid vehicle, while second electric motor 8 operates as a generator and provides the necessary power for the drive by first electric motor 7. For this purpose, the power in torque distributor 11 which is necessary for first electric motor 7 must be taken into account.

Specifically, first electric motor 7 and starting, clutch 2, which is supplied by internal combustion engine 1, act on different drive wheels, or drive axles. Thus, starting clutch 2 is able to act on the rear axle of the hybrid vehicle via a transmission, while first electric motor 7 drives the front axle. In this case, maximum clutch torque M_{Kmax}, which is a function of the operating states of drive units 1, 2, 7, 8, and maximum torque M_{A2max} of first electric motor 7 are also influenced by a traction control system. Maximum torque M_{A2max} of first electric motor 7 is also limited by friction with the roadway surface. The slipping of individual drive axles or drive wheels at small coefficients of friction, for example on account of glazed ice, is prevented by the fact that the starting torque is partially applied to the axle which is driven by internal combustion engine 1 and starting clutch 2.

For some internal combustion engines, an increase in the actual torque of the internal combustion engine is possible only with a time delay, for example for homogeneous combustion due to the delayed build-up of the air charge on account of the intake manifold dynamics. Delays in the range of 100 to 300 milliseconds occur. Clutch torque M_{K} is received at internal combustion engine 1, and may increase only to the extent by which the actual torque of internal combustion engine 1 and the actual torque of second electric motor 8 may be increased. For this purpose, use is made of the limiting of clutch torque M_{K} by maximum clutch torque M_{Kmax}, which is coordinated with the increase in the actual torque.

To achieve more rapid build-up of the actual torque of internal combustion engine 1, a torque reserve is developed at internal combustion engine 1. This is achieved, for example, by an increase in the air charge with simultaneous retardation of the ignition angle. From this state, the ignition angle may be advanced, if necessary, with practically no delay, which is associated with a practically delay-free increase in the actual torque of internal combustion engine 1. The torque reserve at internal combustion engine 1 is requested when setpoint starting torque M_{Anf} is increased but has not yet exceeded maximum torque M_{A2max} of first electric motor 7. This reserve request is made when setpoint starting torque M_{Anf} has approached maximum torque M_{A2max} from below, up to a predefined interval such as 30 Nm, for example. The interval is determined as a function of the speed of operation of the accelerator pedal by the driver and/or as a function of a rate of change in the setpoint starting torque M_{Anf.} A timely request of the torque reserve is made when the interval is increased upon rapid operation of the accelerator pedal.

However, the hybrid vehicle may also be initially started by first electric motor 7 when starting clutch 2 is disengaged and internal combustion engine 1 is shut off. After the request for a start of internal combustion engine 1, approximately 300 to 500 milliseconds elapse until an actual torque of internal combustion engine 1 is available. A start of internal combustion engine 1 is requested when setpoint starting torque M_{Anf} increases, but maximum torque M_{A2max} of first electric motor 7 has not yet been exceeded. Thus, for example, a start is requested when setpoint starting torque M_{Anf} has approached maximum torque M_{A2max} from below, up to a predefined interval such as 50 Nm, for example. Here as well, the interval is determined by the speed of operation of the accelerator pedal by the driver and/or as a function of a change in the rate of change of setpoint starting torque M_{Anf}.

It is possible that internal combustion engine 1 may not start quickly enough. In other words, requested setpoint starting torque M_{Anf} may temporarily not be generated until internal combustion engine 1 has been started and an actual torque is available. In this case, after starting it is advantageous for the actual torque of internal combustion engine 1 as well as clutch torque M_{K} to be built up, i.e., introduced into the drive, not, abruptly, but instead in a ramp-like manner. A sudden acceleration of the vehicle which is not understood by the driver is thus avoided.

1-16. (canceled)

17. A method for starting a hybrid drive of a vehicle having at least a first drive unit and a second drive unit, comprising:
generating by the second drive unit a setpoint starting torque of the hybrid vehicle; and
putting a starting clutch for connecting the first drive unit into a slipping state when a predefined setpoint torque of the second drive unit is exceeded.

18. The method as recited in claim 17, wherein the setpoint starting torque value of the hybrid vehicle is transmitted to the second drive unit, and wherein the predefined setpoint torque value of the second drive unit is limited to a defined maximum torque value.

19. The method as recited in claim 18, wherein the defined maximum torque value of the second drive unit is a function of at least one of: (i) instantaneous operating states of component units of a drive train of the hybrid vehicle; (ii) an instantaneous operating state of an energy storage in the vehicle; and (iii) roadway conditions.

20. The method as recited in claim 18, wherein a clutch torque transmitted by the starting clutch in the slipping state is formed from the difference between the setpoint starting torque value of the hybrid vehicle and the predefined setpoint torque value of the second drive unit limited to the defined maximum torque value.

21. The method as recited in claim 20, wherein the clutch torque is limited to a defined maximum clutch torque as a function of at least one of: (i) an instantaneous operating state of the starting clutch; (ii) an instantaneous operating state of the first drive unit; (iii) an instantaneous operating state of a third drive unit of the vehicle; and (iv) roadway conditions.

22. The method as recited in claim 21, wherein for setting an increase in torque, the setpoint starting torque of the hybrid vehicle is greater than the defined maximum clutch torque.

23. The method as recited in claim 20, wherein a third drive unit of the vehicle is coupled to the first drive unit and driven by the first drive unit for generating power which is used by the second drive unit.

24. The method as recited in claim 23, wherein the clutch torque is distributed between the first drive unit and the third drive unit.

25. The method as recited in claim 23, wherein the torques of the first drive unit, the second drive unit, and the third drive unit are smoothly adapted to the driving operation when rotational speed equality of the an rotational speed and an output rotational speed of the starting clutch is reached.

26. The method as recited in claim 23, wherein the first drive unit is an internal combustion engine, and wherein the second drive unit and third drive unit are electric motors.

27. The method as recited in claim 18, wherein the starting of the hybrid drive is carried out by the second drive unit when the starting clutch is disengaged, while the first drive unit is shut off.

28. The method as recited in claim 27, wherein the first drive unit is started when the setpoint starting torque of the hybrid vehicle increases, but before the setpoint starting torque of the hybrid vehicle exceeds the defined maximum torque value.

29. The method as recited in claim 18, wherein a torque reserve at the first drive unit is requested when the setpoint starting torque of the hybrid vehicle increases, but before the setpoint starting torque of the hybrid vehicle exceeds the defined maximum torque value.

30. The method as recited in claim 28, wherein a deviation of the setpoint starting torque of the hybrid vehicle from the defined maximum torque value is determined as a function of at least one of (i) an operation speed of an accelerator pedal and (ii) a rate of change in the setpoint starting torque of the hybrid vehicle.

31. A hybrid drive system, comprising:
at least a first drive unit and a second drive unit, wherein a setpoint starting torque for starting the hybrid drive system is generated by the second drive unit; and
a control unit configured to bring a starting clutch for coupling the first drive unit into a slipping state when a predefined setpoint torque of the second drive unit is exceeded.

32. The system as recited in claim 31, wherein the second drive unit is connected in a drive train of the hybrid drive system downstream from the starting clutch, and wherein the second drive unit acts on a drive wheel of the hybrid vehicle.
